(19) United States
(12) Patent Application Publication
(10) Pub. No.: US 2020/0133336 A1
(43) Pub. Date: Apr. 30, 2020

(54) ELECTRONIC DEVICE WITH DUAL DISPLAY

(71) Applicant: Hewlett-Packard Development Company, L.P., Spring, TX (US)

(72) Inventor: Ren-San Wang, Shanghai (CN)

(21) Appl. No.: 16/481,841

(22) PCT Filed: Jul. 17, 2017
(86) PCT No.: PCT/CN2017/093147

§ 371 Date: Jul. 30, 2019

(51) Int. Cl. G06F 1/16

(52) U.S. Cl. CPC G06F 1/1616; G06F 1/1649; G06F 1/1681; G06F 1/169; G06F 1/165

(57) ABSTRACT

A base portion (104) of an electronic device (100) is described, which may include a first portion (106) having a keyboard (110) and a second portion (108) pivotally connected to the first portion (106) at a first end (116) and pivotally connected to a first display (102) of the electronic device (100) at a second end (118). The second portion (108) may include a second display (112) and a touchpad (114).

### BACKGROUND

The emergence and popularity of mobile computing has made electronic devices, due to their compact design and light weight, a staple in today's marketplace. Example electronic devices may include laptop computers, notebook computers, and the like, that can be utilized for multiples tasks. Such electronic devices may include a display, a keyboard, and other electronic circuitries that are housed in an enclosure. Example enclosure may include an upper housing for accommodating the display and a lower casing for accommodating the keyboard and the other electronic components.

### BRIEF DESCRIPTION OF THE DRAWINGS

Examples are described in the following detailed description and in reference to the drawings, in which:

FIG. 1A is a perspective view of an example base portion of an electronic device, including a first portion and a second portion that are pivotally connected;

FIG. 1B is a side view of the example base portion, as shown in FIG. 1, depicting a non-pivoted position of the second portion relative to the first portion;

FIG. 1C is a side view of the example base portion, as shown in FIG. 1, depicting a pivoted position of the second portion relative to the first portion;

FIG. 2A is an isometric view of an example electronic device with a second display and a touchpad in a non-pivoted position relative to a keyboard;

FIG. 2B is an isometric view of the example electronic device, as shown in FIG. 2A, depicting the second display and touchpad in a pivoted position relative to the keyboard;

FIGS. 3A and 3B depict example schematic views of different heights and viewing angles of the first display corresponding to FIGS. 2A and 2B, respectively; and

FIG. 4 is an example electronic device, such as those shown in FIGS. 1 and 2, depicting a different screen content between the first display and the second display.

### DETAILED DESCRIPTION

Electronic devices, such as notebook computers, may include an upper housing for accommodating a display and a lower housing for accommodating a keyboard, a touchpad and other electronic circuitries. The touchpad is provided in the lower housing, for instance, in the middle of the hand rest area below the keyboard. Further, the upper housing and lower housing may be connected to each other via hinge mechanism such that the upper housing may be rotated about a hinge axis relative to the lower housing. In such devices, the upper housing is hinged at a fixed axis relative to the lower housing, and hence can include a limited display adjustment. For example, the hinge axis cannot be raised above the keyboard level for providing a better viewing angle of the display. Such ergonomics may cause neck and back ailments to the user. Further, the electronic device with a single display may not support the multiple tasking such as email, internet surfing, gaming, and/or media capture/playback to be performed simultaneously.

Example described herein may provide a second display and a touchpad in a base portion of an electronic device. The base portion may include a first portion (e.g., towards a front edge) having a keyboard and a second portion (e.g., towards a back edge) having the second display and the touchpad. The second portion may be pivotally connected to the first portion at one long side via a first hinge assembly. Further, the second portion may be pivotally connected to a first display (i.e., main screen) of the electronic device at opposite long side via a second hinge assembly.

Examples described herein may provide a second display in the base portion, which may provide another choice to users to review screen. Further, examples described herein may enable effective utilization of the base portion by positioning the touchpad in the second portion without compromising on a size of the keyboard. Furthermore, the first hinge assembly may lift the first display, the second display, and the touchpad to improve ergonomics.

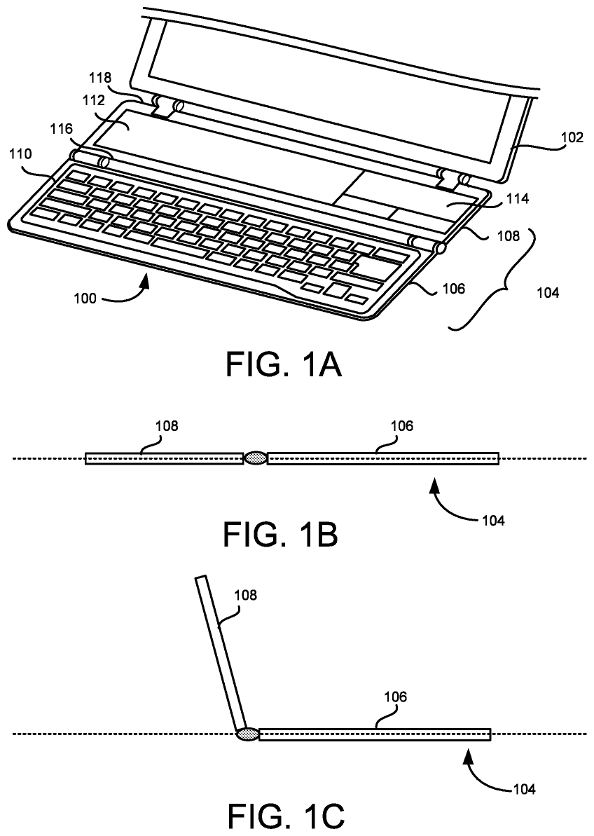

FIG. 1A is a perspective view of an example base portion 104 of an electronic device 100. Example electronic device 100 may include a notebook computer, convertible device, tablet, or any other device having a display and a base portion that are pivotally connected to each other. Example convertible device may refer to a device that can be “converted” from a laptop mode to a tablet mode. As shown in FIG. 1A, electronic device 100 may include a first display 102 and base portion 104 pivotally coupled to first display 102. Example first display 102 may include liquid crystal display (LCD), light emitting diode (LED), electro-luminescent (EL) display, or the like.

Base portion 104 may include a first portion 106 and a second portion 108 pivotally connected to first portion 106. In one example, second portion 108 may be pivotally connected to first portion 106 at a first end 116 (e.g., a long side) of second portion 108. First portion 106 may include a keyboard 110 and second portion 108 may include a second display 112 and a touchpad 114. In one example, first portion 106 may be disposed towards a front edge of base portion 104 and second portion may be disposed towards a back edge of base portion 104 such that keyboard 110 is provided below second display 112 and touchpad 114. First portion 106 and second portion 108 may accommodate respective electronic components such as a battery, printed circuit board (PCB), data communication port, and the like.

Further, second portion 108 may be pivotally connected to first display 102 at a second end 118 (i.e., opposite to first end 116) of second portion 108. Second portion 108 may be pivoted to multiple orientations and retracted to a non-pivoted position with respect to first portion 106 as described in FIGS. 1B and 1C.

FIGS. 1B and 1C depict a non-pivoted position and a pivoted position of second portion 108 relative to first portion 106 of base portion 104, respectively. As shown in FIG. 1B, second portion 108 may be coplanar with first portion 106 when second portion 108 is in the non-pivoted position. In this scenario, electronic device 100 can be used in normal operating position. As shown in FIG. 1C, second portion 108 may be inwardly rotatable to a pivoted position relative to first portion 106. In one example, the relative angle of rotation of second portion 108 may be in a range of 180 degrees to 0 degrees, particularly, 180 degrees to 90 degrees. In this case, second display 112 and touchpad 114 may be pivoted to an angled position.

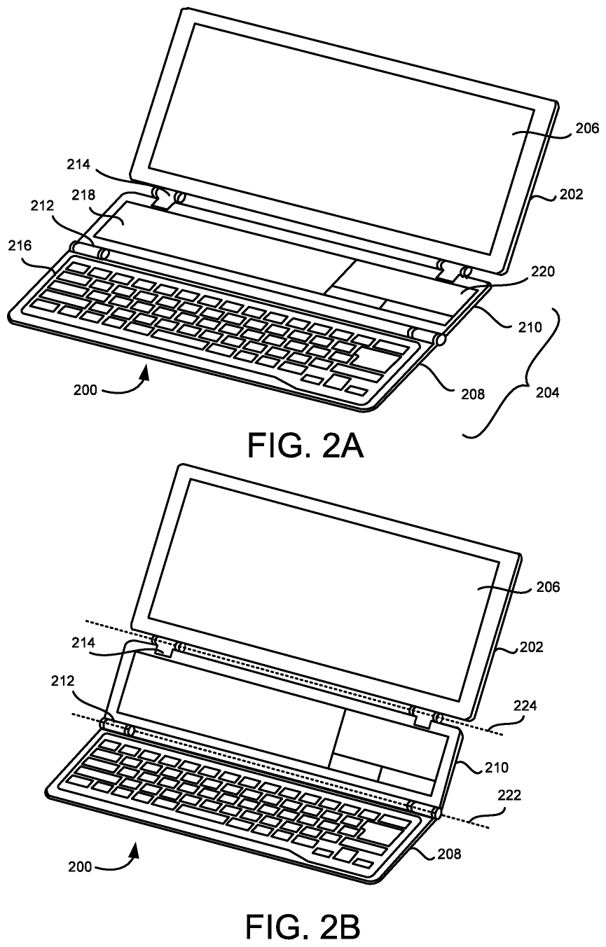

FIG. 2A is an isometric view of an example electronic device 200 with a second display 218 and touchpad 220 in a non-pivoted position relative to a keyboard 216. FIG. 2B is an isometric view of example electronic device 200 depicting second display 218 and touchpad 220 in a pivoted position relative to keyboard 216. As shown in FIGS. 2A and 2B, electronic device 200 may include an upper housing 202 and a lower housing 204. The terms “lower housing” and “base portion” may be used interchangeably throughout the document. Example upper housing 202 may include a first display 206. Lower housing 204 may include a first portion 208 and a second portion 210 pivotally connected to first portion 208. First portion 208 may include keyboard 216 and second portion 210 may include second display 218 and touchpad 220 disposed adjacent to second display 218.

In some examples, both first display 206 and second display 218 may be touch-screen displays. In one example, touchpad 220 may be used to provide cursor input on graphical user interfaces (GUIs) of first display 206 while second display 218 may enable touch interactions and capable of operating independently from first display 206. Touchpad 220 may include left and right click buttons for providing the inputs. For example, cursor input may include input functionality such as pointing, dragging, tapping, double tapping, scrolling, panning, zooming and rotating the contents presented on GUIs.

Alternately, touchpad 220 may be used to control second display 218 while first display 206 may enable touch interactions. In other examples, touchpad 220 can be used to control both first display 206 and second display 218, for instance, using a switch option. The switch option can be selected in the electronic device 200, for example via control settings, to enable switching touchpad control between first display 206 and second display 218.

Further, first display 206 may include a width that corresponds to a combined width of second display 218 and touchpad 220. In one example, second display 218 may include dimensions (i.e., width and height) less than dimensions of first display 206. In one example, first display 206 may abut against keyboard 216, second display 218, and touchpad 220 in lower housing 204 when first display 206 is closed relative to lower housing 204. Further, keyboard 216, second display 218, and touchpad 220 in lower housing 204 are available for user access when first display 206 is opened relative to lower housing 204.

First portion 208 may be pivotally connected to second portion 210 via at least one first hinge 212. Further, upper housing 202 may be pivotally connected to second portion 210 via at least one second hinge 214. The first hinge 212 and second hinge 214 described herein may refer to separate hinge assemblies. For example, first portion 208 of electronic device 200 may be situated towards a front edge of base portion 204 away from second hinge 214. The remaining surface area (i.e., back edge) of base portion 204 may include second portion (i.e., second display 218 and touchpad 220) positioned adjacent to second hinge 214 (i.e., between first hinge 212 and second hinge 214). Base portion 204 may include trackpad/touchpad 220 placed towards the right edge region of second portion 210 and remaining space of second portion 210 can be used for accommodating second display 218.

Further, second display 218 may be in communication with first portion 208 including keyboard 216 via first hinge 212. First display 206 may be in communication with first portion 208 including keyboard 216 via first hinge 212 and second hinge 214. First hinge 212 and second hinge 214 can be disposed at opposite long sides of second portion 210. In one example, first hinge 212 may be positioned at a first-long side of second portion 210 so as to permit pivotal movement of second portion 210 relative to first portion 208 about a first axis of rotation 222. Further, second hinge 214 may positioned at a second-long side of second portion 210 so as to permit pivotal movement of first display 206 relative to second portion 210 about a second axis of rotation 224. Example first hinge 212 and second hinge 214 may include independent and parallel axes of rotation.

As shown in FIG. 2A, when second portion 210 is in a non-pivoted position, second portion 210 may be coplanar with first portion 208. In the non-pivoted position, second display 218 may function as a head-down display (HDD) with respect to the user. As shown in FIG. 2B, second portion 210 may be inwardly rotatable to a pivoted position relative to first portion 208 along first axis of rotation 222. In this case, second display 218 may function as a heads-up display (HUD) with respect to the user. In one example, second portion 210 may be held at an angle (e.g., between 180 degrees and 90 degrees) relative to first portion 208 to adjust a height and a viewing angle of first display 206. Second display 218 may be joined to first hinge 212 that allows a user to orient second display 218 relative to first portion 208 from a flat position to an angled position.

Further, upper housing 202 may be rotated relative to second portion 210 along second axis of rotation 224. The relative angle of rotation of upper housing 202 about second axis of rotation 224 may be in a range of 0 degree to 360 degree such that first display 206 may be rotated to multiple orientations relative to base portion 204. However, when second portion 210 is pivoted, the angle of connection between second portion 210 and first display 206 may include an angle between 180 degrees and zero degrees.

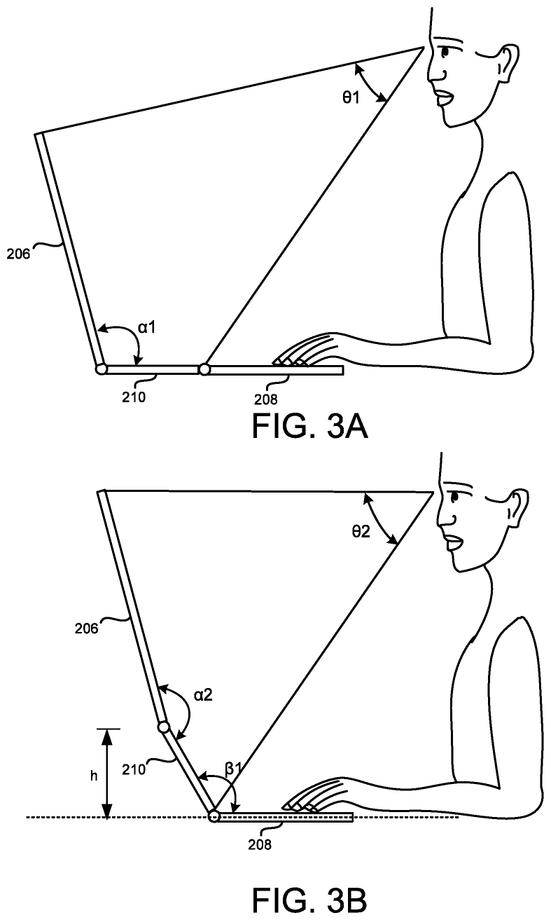

FIGS. 3A and 3B depict example schematic views of electronic device illustrating heights and viewing angles of first display 206 corresponding to FIGS. 2A and 2B, respectively. As shown in FIG. 3A, consider first display 206 is pivoted to an angle α1 relative to second portion 210 while first portion 208 and second portion 210 are rested on a horizontal surface. In this case, user may view first display 206 and second display 218 at a viewing angle θ1.

As shown in FIG. 3B, consider second portion 210 is pivoted to an angle β1 relative to first portion 208. In this case, second display 218 and touchpad 220 may be positioned in a slanted orientation for the user access. Further, first display 206 may be lifted to a height h from the keyboard level. Further, the first display may be adjusted (e.g., from angle α1 to an angle α2) such that user may view first display 206 at a viewing angle θ2.

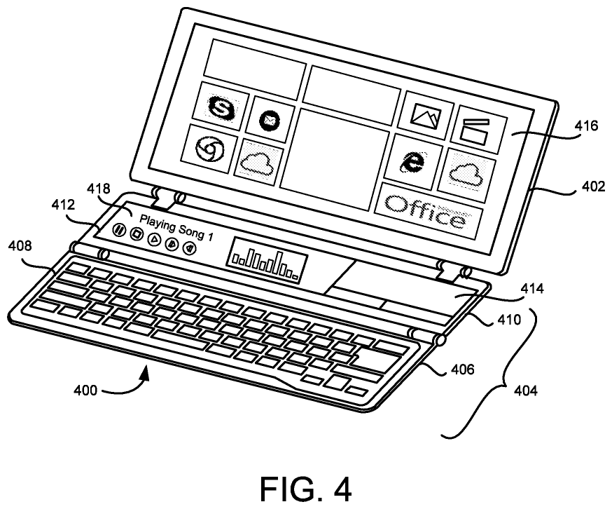

FIG. 4 is an example electronic device 400, such as those shown in FIGS. 1 and 2, depicting a different screen content between first display 402 and second display 412. As shown in FIG. 4, electronic device 400 may include a first display 402 and a base portion 404. Base portion 404 may include a first portion 406 having a keyboard 408 and a second portion 410 having a second display 412 and a touchpad 414 substantially adjacent to second display 412.

First display 402 and second display 412 may simultaneously output different user interfaces (e.g., 416 and 418). Example second display 412 may be a touch-screen display and is capable of operating independently from first display 402. In one example, first display 402 can render a browser application while second display 412 can play video content associated with a different application.

In another example, first display 402 may output a first content associated with an application, and second display 412 may render control options to control the first content outputted on first display 402. For example, first display 402 can render a video content while second display 412 can provide control options (e.g., play, pause, shuffle, and the like) to control the video content associated with first display 402. In yet another example, second display 412 may render application toolbars, content menu, or active application list for easily switching between active applications on first display 402. In addition, second display 412 may display supplemental information associated with a game to a user while the user is playing the game on first display 402. In this case, both touchpad 414 and keyboard 408 can be used to provide inputs to control the game.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A base portion of an electronic device, comprising:
a first portion having a keyboard; and
a second portion pivotally connected to the first portion at a first end and pivotally connected to a first display of the electronic device at a second end, wherein the second portion comprises a second display and a touchpad.

2. The base portion of claim 1, wherein the first display is having a width that corresponds to a combined width of the second display and the touchpad, and wherein the second display is a touch-screen display.

3. The base portion of claim 1, comprising:
at least one first hinge to pivotally connect the second portion to the first portion at the first end, wherein the second portion is pivotally connected to the first display of the electronic device at the second end via at least one second hinge.

4. The base portion of claim 1, wherein the second portion is coplanar with the first portion when the second portion is in a non-pivoted position.

5. The base portion of claim 1, wherein the second portion is inwardly rotatable to a pivoted position relative to the first portion, and wherein the second portion is to adjust a height and a viewing angle of the first display when the second portion is in the pivoted position.

6. An electronic device, comprising:
an upper housing having a first display; and
a lower housing comprising:
a first portion having a keyboard; and
a second portion having a second display and a touchpad;
at least one first hinge to pivotally connect the first portion to a first end of the second portion; and
at least one second hinge to pivotally connect the upper housing to a second end of the second portion.

7. The electronic device of claim 6, wherein the second display includes dimensions less than dimensions of the first display, and wherein the first display abuts against the keyboard, the second display, and the touchpad when the upper housing is closed relative to the lower housing.

8. The electronic device of claim 6, wherein the second portion is coplanar with the first portion when the second portion is in a non-pivoted position, wherein the second portion is inwardly rotatable to a pivoted position relative to the first portion, and wherein the second portion is to adjust a height and a viewing angle of the first display when the second portion is in the pivoted position.

9. The electronic device of claim 6, wherein the second display is a touch-screen display to enable touch interactions, and wherein the second display is capable of operating independently from the first display.

10. An electronic device, comprising:
a first display; and
a base portion, wherein the base portion comprising:
a first portion having a keyboard; and
a second portion having a second display and a touchpad substantially adjacent to the second display, wherein the second portion is pivotally connected to the first portion, wherein the first display is pivotally connected to the second portion, and wherein the first display and the second display are to simultaneously output different user interfaces.

11. The electronic device of claim 10, comprising:
a first set of hinges to pivotally connect the second portion to the first portion; and
a second set of hinges to pivotally connect the first display to the second portion.

12. The electronic device of claim 10, wherein the first display is having a width that corresponds to a combined width of the second display and the touchpad.

13. The electronic device of claim 10, wherein the second display comprises dimensions less than dimensions of the first display, and wherein the first display abuts the keyboard, the second display, and the touchpad when the first display is closed relative to the base portion.

14. The electronic device of claim 10, wherein the second display is a touch-screen display, and wherein the second display is capable of operating independently from the first display.

15. The electronic device of claim 10, wherein the first display is to output a first content associated with an application, and wherein the second display is to render control options to control the first content or to select another application to be outputted on the first display.
